(19) United States
(12) Patent Application Publication
(10) Pub. No.: US 2026/0247173 A1
(43) Pub. Date: Aug. 20, 2026

(54) Determining Frequency Periodicities For Decision Making For Operation Of A Service In A Communication Network

(71) Applicant: Telefonaktiebolaget LM Ericsson (publ), Stockholm (SE)

(72) Inventors: Hossein SHOKRI GHADIKOLAEI, Täby (SE); Milad GANJALIZADEH, Stockholm (SE); Johan HARALDSON, Stockholm (SE); Athanasios KARAPANTELAKIS, Solna (SE)

(73) Assignee: Telefonaktiebolaget LM Ericsson (publ), Stockholm (SE)

(21) Appl. No.: 19/161,776

(22) PCT Filed: Sep. 20, 2023
(86) PCT No.: PCT/IB2023/059306

§ 371 Date: Sep. 3, 2025

(30) Foreign Application Priority Data
Mar. 3, 2023 (GR) 20230100185

(51) Int. Cl. H04W 24/02

(52) U.S. Cl. CPC H04W 24/02

(57) ABSTRACT

A computer-implemented method performed by a computing device determine a plurality of frequency periodicities for decision making for an operation of at least one service in a communication network is provided. The method includes determining a first frequency periodicity for a first decision variable for the operation of the at least one service. The method further includes determining a second frequency periodicity for a second decision variable for the operation of the at least one service. The first frequency periodicity is different than the second frequency periodicity. The method further includes outputting the first frequency periodicity for the first decision variable and the second frequency periodicity for the second decision variable. Related methods and apparatus are also provided.

### TECHNICAL FIELD

The present disclosure relates generally to computer-implemented methods performed by a computing device to determine a plurality of frequency periodicities for decision making for an operation of at least one service in a communication network, and related methods and devices.

### BACKGROUND

There is growing interest in using sequential optimization approaches, also referred to as hierarchical optimization in a radio access network (RAN), in which some functions/intents can be optimized on higher time scales and some others on lower time scales. Examples include joint optimization of beamforming and base station (BS) association, in which beamforming vectors may be optimized in every coherence interval, while the BS association decision can remain the same for many coherence intervals. Other examples include joint scheduling/power control and network slicing.

### SUMMARY

There currently exist certain challenge(s). Some approaches may either (1) seek to optimize decision variables with a lower frequency than an optimal frequency, which may result in poor performance in target key performance indicators (KPIs), or (2) seek to optimize decision variables with a higher frequency than optimal, which may result in extra signaling (which may correspond to higher energy and communication resources). Such approaches lack optimizing or improving a frequency of a control loop, that is, optimizing/improving the frequency of decision makings at different levels of hierarchical environment.

Certain aspects of the disclosure and their embodiments may provide solutions to these or other challenges.

Some embodiments provide a computer-implemented method performed by a computing device to determine a plurality of frequency periodicities for decision making for an operation of at least one service in a communication network. The method includes determining a first frequency periodicity for a first decision variable for the operation of the at least one service. The method further includes determining a second frequency periodicity for a second decision variable for the operation of the at least one service. The first frequency periodicity is different than the second frequency periodicity. The method further includes outputting the first frequency periodicity for the first decision variable and the second frequency periodicity for the second decision variable.

Other embodiments provide a computing device configured to determine a plurality of frequency periodicities for decision making for an operation of at least one service in a communication network. The computing device includes processing circuitry; and memory coupled with the processing circuitry. The memory includes instructions that when executed by the processing circuitry causes the computing device to perform operations. The operations include to determine a first frequency periodicity for a first decision variable for the operation of the at least one service. The operations further include to determine a second frequency periodicity for a second decision variable for the operation of the at least one service. The first frequency periodicity is different than the second frequency periodicity. The operations further include to output the first frequency periodicity for the first decision variable and the second frequency periodicity for the second decision variable.

Some embodiments provide a non-transitory computer readable medium. The non-transitory computer readable medium includes program code to be executed by processing circuitry of a computing device configured to determine a plurality of frequency periodicities for decision making for an operation of at least one service in a communication network. Execution of the program code causes the program code to perform operations. The operations include to determine a first frequency periodicity for a first decision variable for the operation of the at least one service. The operations further include to determine a second frequency periodicity for a second decision variable for the operation of the at least one service. The first frequency periodicity is different than the second frequency periodicity. The operations further include to output the first frequency periodicity for the first decision variable and the second frequency periodicity for the second decision variable.

Certain embodiments may provide one or more of the following technical advantage(s). Based on determining frequency of decision makings at different levels, the method may provide improved performance of hierarchical decision making tools (e.g., a computational model or hierarchical reinforcement learning (HR-L)) in edge computing for cellular networks, for example. The method may further provide compatibility with fast decision making cycles and/or improved decision cycles.

### BRIEF DESCRIPTION OF THE DRAWINGS

The accompanying drawings, which are included to provide a further understanding of the disclosure and are incorporated in and constitute a part of this application, illustrate certain non-limiting embodiments of the present disclosure. In the drawings:

FIG. 1 is a schematic diagram illustrating an example of a high-level architecture that includes a multi-level HRL orchestrator in accordance with some embodiments;

FIG. 2 is a schematic diagram illustrating a multi-level HRL orchestrator for coexistence of two services an open-RAN (O-RAN) aligned architecture according to some embodiments;

FIG. 3 is a schematic diagram illustrating an overall HRL control architecture that includes a computing device according to some embodiments;

FIG. 4 is a sequence diagram for the example shown in FIG. 3 according to some embodiments;

FIG. 5 is a flow chart illustrating operations of a computing device according to some embodiments;

FIG. 6 is a block diagram of computing device according to some embodiments;

FIG. 7 is a block diagram of a communication system in accordance with some embodiments; and

FIG. 8 is a block diagram of a virtualization environment in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of the present disclosure are shown. Inventive concepts may, however, be embodied in many different forms and should not be construed as limited to the embodiments set forth herein. Rather, these embodiments are provided so that this disclosure will be thorough and complete, and will fully convey the scope of the present disclosure to those skilled in the art. It should also be noted that these embodiments are not mutually exclusive. Components from one embodiment may be tacitly assumed to be present/used in another embodiment.

In some approaches, decision variables cannot be tuned at the same time due to, e.g., hardware or protocol constraints. Moreover, even if decision variables can be tuned at the same time, such tuning may result in unnecessary overhead (e.g., massive overhead), as decisions on higher time frames may not need to be recalculated on a fine time resolution.

In some approaches, when hierarchical decision making is employed, a decision frequency is sometimes imposed by the application. For example, beamforming in every coherence interval. However, in some use cases, the decision frequency may be controlled. For example, a BS association decision may be optimized regularly to balance network loads, reduce total power consumption, or improve network throughput. It may be desirable, however, to optimize the frequency of both power control and slicing decisions, as optimization of these decisions may not be needed in every coherence interval or according to a standard in any predefined intervals. In another example, it may be desirable to optimize operation of ultra-reliable low latency communications (URLLC) though joint optimization of (1) slicing to control resources in terms of, e.g., bandwidth or power, (2) a modulation and coding scheme (MCS) to control packet transmission reliability, and (3) a number of retransmissions to control packet transmission reliability. It also may be desirable to optimize MCS in every slot, whereas the maximum number of retransmissions (nRet) or slicing may be unchanged for many slots, for example.

Moreover, it may be desirable to optimize a decision making frequency of hierarchical reinforcement learning (HRL) actions in order to, e.g., keep network operation at an optimal level over time. However, such optimization may be a challenging task as increasing the frequency may imply higher overheads; taking an action decision every time may need collection of network-wide information (e.g., information which corresponds to energy and communication resources); and a complicated optimization problem may need to be solved which may result in computation, energy, and/or memory costs.

For URLLC service and slicing, for example, URLLC performance KPIs (such as communications service availability) are a function of slicing, a number of retransmission (nRet), and MCS. Increasing slice resources (e.g., bandwidth) of URLLC may generally improve the availability and reliability of the service. Increasing nRet and/or decreasing the MCS may enhance the availability given that the allocation of enough communication resources to the URLLC service. However, without enough resources (such as lack of sufficient bandwidth), lower MCS, or a higher nRet may result in higher delay and lower availability.

However, due to the existence of a limited number of resources to be shared between URLLC and enhanced mobile broadband (eMBB) services, for example, an appropriate slicing approach may be needed. In some applications, limitations on hardware, software, or protocol may not allow for optimizing all the decision variables together. For example, it may not be permissible to change the bandwidth during an operational phase and/or on the same time scale as other parameters. This may be due to protocol limitations since changing bandwidth, processing capabilities, or slice allocation may happen at a core network after getting data from a number of network nodes (e.g., gNodeBs (gNBs)), while per-network node decisions can happen locally. Similarly, there may be a similar challenge for changing MCS and/or nRet.

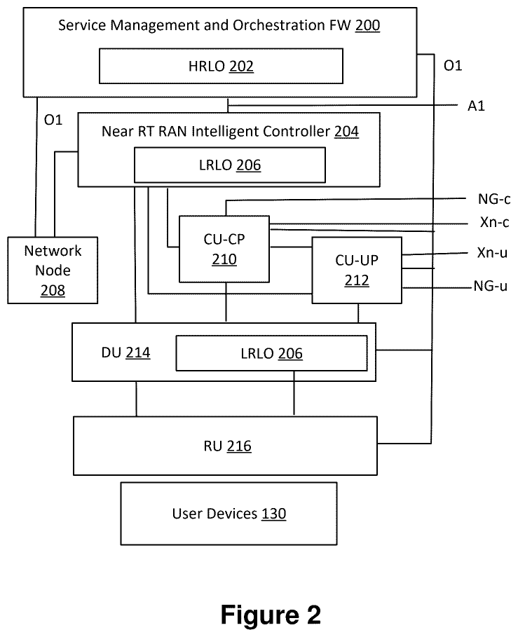

Thus, some approaches for optimizing decision variable together may not be applicable or may result in unnecessarily high memory, processing power, and/or extra communication overheads. In some approaches, limitations on hardware, software, or protocol may not allow for optimizing the decision variables together (slicing, nRet, and MCS in examples herein). For URLLC examples discussed herein, it may not be preferable or may not be possible to change slicing in every slot due to, for example, unnecessarily high memory and extra communications overheads. Moreover, when the frequency of this control loop is reduced, it may be deployed on an edge cloud, as shown in FIG. 2 (discussed further herein), which may substantially reduce needed signalling, energy consumption to run the loop, and communication overhead.

Traditional horizontal reinforcement learning (RL) approaches may train all decision variables on the same timescale. However, in many telecommunications use cases, for example, the decision variables may need to be optimized on different time frames. For example, adaptive modulation and coding or beamforming may be designed for every time slot, whereas routing decisions or BS association variables may remain the same for many time slots. Forcing the decisions variables to be optimized in every time slot may unnecessarily complicate the decision space and may massively increase energy consumption, processing, and communications. While HRL in some approaches may address this challenge by optimizing the decision variables on different time scales, such approaches lack optimization of a frequency of the control loop. In other words, such approaches lack optimizing the frequency of decision makings at different levels of HRL.

Some approaches include seeking to optimize, e.g., URLLC coexisting with another service using one control loop (e.g., via flat RL) or multiple control loops (e.g., via HRL). However, such approaches lack optimizing or improving the frequency of the control loop. That is such approaches lack optimizing/improving the frequency of decision makings at different levels of a hierarchy.

Thus, some approaches either (1) may seek to optimize decision variables with lower frequency than an optimal frequency, which may result in poor performance in target KPIs (e.g., availability for URLLC) or excessive use of resources (e.g., bandwidth and power), or (2) may seek to optimize decision variables with a higher frequency than optimal, which may result in extra signaling (which can also correspond to higher energy and communication resources).

Methods for determining the frequency of decision makings at different levels of a hierarchy may be lacking.

Certain aspects of the disclosure and their embodiments may provide solutions to these or other challenges.

Examples of the present disclosure are discussed in the non-limiting context of using either a computational model (e.g., a stochastic subgradient method) or a RL model to optimize or improve the operation of URLLC though joint optimization of a slicing decision variable at a higher level, and nRet and MCS decision variables at a low level. In the examples, each of these decision variables can be updated at different frequencies. As a consequence, an availability requirement may be met for a URLLC service coexisting with eMBB or other services with a predetermined KPI intent(s). It is noted, however, that the present disclosure is not so limited and includes other applications of the methods herein in which the frequency of a control loop(s) is optimized or improved.

As used herein, a process of changing decision variables is referred to as a “control loop”. For example, in the above use case, a control loop may change the MCS, the maximum number of retransmissions, or the slicing decisions.

Operations of examples may optimize or improve decision making frequency inside HRL. Discussion of communication between an orchestrator and an environment is included herein in the context of an example using an HRL-powered nRet and MCS selection (as low-level decision variables) and management of network slicing for URLLC and eMBB services (as high-level decision variables). Considering these two levels, an objective of the HRL model is to maintain availability requirements of the URLLC service and rate requirements of the eMBB service.

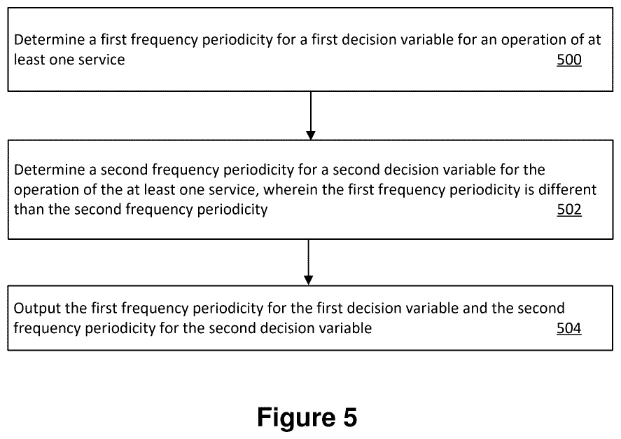

As discussed further herein with reference to FIG. 5, some embodiments herein are directed to a computer-implemented method performed by a computing device to determine a plurality of frequency periodicities for decision making for an operation of at least one service in a communication network. The method includes determining (500) a first frequency periodicity for a first decision variable for the operation of the at least one service. The method further includes determining (502) a second frequency periodicity for a second decision variable for the operation of the at least one service. The first frequency periodicity is different than the second frequency periodicity. The method further includes outputting (504) the first frequency periodicity for the first decision variable and the second frequency periodicity for the second decision variable.

In some embodiments, the outputting (operation 504 in FIG. 5) is to at least one controller and at least one control loop for the decision making on the first and second decision variables for operation of the at least one service.

In other embodiments, the outputting (operation 504 in FIG. 5) is to a plurality of controllers for a plurality of control loops for the decision making on the first and second decision variables for operation of the at least one service; and the plurality of control loops include a first control loop for the decision making on the first decision variable at the first frequency periodicity and a second control loop is for the decision making on the second decision variable at the second frequency periodicity.

In some embodiments, the first frequency periodicity is for a first decision on the first decision variable at a first level of a HRL model for the operation of the least one service, and the second frequency periodicity is for a decision on the second decision variable at a second level of the HRL model for the operation of the least one service.

In one example, a multi-level HRL orchestrator is included that includes high-level orchestration and low-level orchestration.

For high-level orchestration, examples of the present disclosure may fulfill various, and sometimes contradictory, requirements of different services. As a consequence, in some examples, minimal overhead may be used to support high level intents over time through the use of HRL, as well as optimized frequency of control loops.

For low-level orchestration, examples of the present disclosure may optimize a frequency of decision making. A decision may be a function of the environment but can also depend on the high level decision(s) and its update frequency.

Examples of such joint optimization are provided herein that focus on bandwidth and transmit power as network resources that are optimized/designed by a control loop of the higher level of HRL. However, the present disclosure is not so limited and includes other network resources and use cases.

Some examples herein using HRL include a high-level orchestrator of the HRL that interacts with the environment and orchestrates the decision-making frequency considering the importance of different temporal and behavioral abstraction.

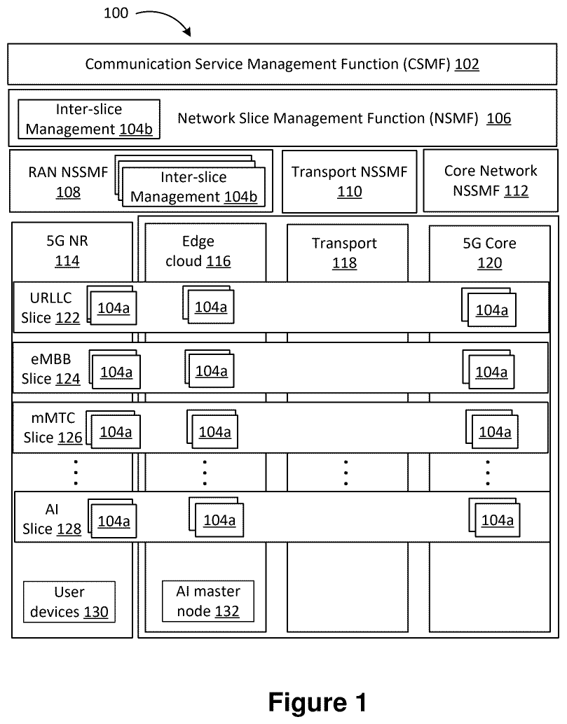

FIG. 1 is a schematic diagram illustrating an example of a high-level architecture 100 that includes a multi-level HRL orchestrator in inter-slice management 104b and intra-slice management 104a in accordance with embodiments. The architecture 100 includes: Communication Service Management Function (CSMF) 102, which is a customer order management layer for an operations support system and business support system (OSS/BSS) capability; network slice management function (NSMF) 106 that includes inter-slice management 104b (discussed further herein); RAN network slice subnet management function (NSSMF) 108 that includes inter-slice management 104b, transport NSSMF 110, and core network NSSMF 122; and various network levels including RAN 114 (e.g., fifth generation (5G) new radio (NR) that includes user devices 130 (which can include industrial devices), edge cloud 116 that includes an artificial intelligence (AI) master node 132, transport level 118, and a 5G core 120.

The architecture in FIG. 1 is shown for inter 104b and intra-slice management 104a for an example that includes the co-existence of eMBB and URLLC services among other services including, without limitation, massive machine type communications (mMTC) services of mMTC slice 126 and AI services of slice 128. Intra-slice management functions 104a can reside in various network levels, including 5G NR RAN 114, edge cloud 116, or inside 5G core 120. Inter-slice management functions 104b also can be hosted in RAN subnet 108 or in NSMF 106. Operations of examples of the present disclosure can be performed at the same place where a high level orchestrator of the HRL resides.

In the architecture shown in FIG. 1, an intra-domain NSSMF 108 is included that provides management services for one or more network slice subnets. NSSMF 108 is a domain-level management function governed by an end-to-end NSMF 106. Further, in the architecture in FIG. 1, orchestrations within a slice (e.g., low-level policy on nRet and MCS selection) are implemented as a virtual network function(s) (VNFs) orchestrator on NSSMF 108 controlling its corresponding slice. However, the HRL orchestrator high level policy (e.g., slices' bandwidth and power) in this example are implemented as a VNF on NSMF 106 or NSSMF 108, depending on the set of resources and if such a set includes transport or core network resources, with interfaces enabling the communication between the two orchestrators. A frequency component (in a computing device, for example) can be hosted in CSMF 102 or NSMF 106, but if all decisions of HRL are below NSSMF 108, the frequency component can reside in NSMMF 108.

FIG. 2 is a schematic diagram illustrating a multi-level HRL orchestrator that includes a high level HRL orchestrator (HRLO) 202 and a low level HRL orchestrator (LRLO) 206 for coexistence of eMBB and URLLC in an O-RAN aligned architecture according to some embodiments. In FIG. 2, the architecture includes a service management and orchestration framework (FW) 200 that includes HRLO 202 and a near real-time (RT) RAN intelligent controller (RIC) 204. LRLO 206 can be hosted in near RT RIC 204 or in a distributed unit (DU) 214. Additionally or alternatively, LRLO 206 can be multiplied, for example, in the case of multi-agent RL use cases. As shown in FIG. 2, the O-RAN architecture includes DU 214 and a radio unit (RU) 216. The near RT RIC 204 provides xApps cloud-based infrastructure for controlling a distributed collection of RAN infrastructures (including network node 208 (e.g., eNodeB, gNB, etc.), centralized unit-control plane (CU-CP) 210, centralized unit-user plane (CU-UP) 212, and DU 214 in an area via an O-RAN protocol. The architecture also includes interfaces for operators, include A1 and O1 interfaces as shown.

In some embodiments, for example, one of the first frequency periodicity and the second frequency periodicity has a higher periodicity than a periodicity of the other of the first frequency periodicity and the second frequency periodicity; the one of the first frequency periodicity and the second frequency periodicity that has the higher periodicity is output to a first orchestrator for the at least one service that interacts with the communication network and orchestrates a control of the plurality of frequency periodicities for the decision making; and the other of the first frequency periodicity and the second frequency periodicity is output to a second orchestrator for the at least one service.

In an example, availability A of at least one service is defined as [A]:={1, . . . , A} for some positive scalar A. Without loss of generality and for ease of discussion, in this example, [B] gNBs serve a set of [U] URLLC and [M] eMBB devices.

In this example, for URLLC, application-layer availability of the URLLC service is the target KPI; and for eMBB, a target throughout is the target KPI. The eMBB throughout τ and URLLC availability A are functions of low-level π^{U} (nRet and MCS selection in this example) and high level P (slicing decision, e.g., bandwidth, power, or processing capability, in this example).

In some embodiments, at least one control loop is subject to at least one constraint on at least one of the first frequency periodicity and the second frequency periodicity based on a network protocol and/or hardware related to the operation of at least one service.

For example, the above example further includes the following slicing constraint: [C]:={1, . . . , c, . . . , C} that defines a set of normalized resources allocated to S slices (e.g., bandwidth, power, processing capability, etc.); [S] defines the set of slices (URLLC slice 122 and eMBB slice 124, in this example); and ρ^{s}∈[0,1]^{C}, ∀s∈[S] defines a ratio of resources that are allocated to slice c. Consequently, NSSMF 108 should keep the following condition:

$${\sum }_{s = 1}^{S} {[ {ρ}^{s} ]}_{c} \leq 1 , ∀ c ∈ [ C ] , \qquad ( 1 )$$

where [ρ^{s}]_{c} denotes the c-th element of vector ρ^{s}. For example, when a resource power p is shared between URLLC slice 122 and eMBB slice 124, and if the URLLC service requires p_{URLLC}power, there is only up to p-p_{URLLC} for the eMBB service. All decision variables of the higher level in P are concatenated via P:=[ρ^{s}]_{s∈[s]}. This problem is then mapped to a HRL framework and a RL model is trained to take optimal decisions on lower and higher time scales. After convergence, new decisions at frequency fₗ on the lower level and fₕ at the higher level can be taken.

In some embodiments, a first decision is made for the first decision variable at the first frequency periodicity and a second decision is made for the second decision variable at the second frequency periodicity.

In some examples, taking these decisions may lead to overhead O which is a function of fₗ, fₕ, π^{U}, and P as well as network dynamics, modelled through an underlying Markov decision process of RL.

An objective of examples of the present disclosure is to reduce or minimize the inference overhead O. Given fₗ and fₕ, optimal π^{U} and P may be found for an environment. Then that information can be used to update (fₗ, fₕ), and this process may be continued until a value or a region of (fₗ, fₕ) is found in which the inference overhead is small enough without much affect on the performance of the HRL.

In some embodiments, the first decision and the second decision result in a reduction or a minimization of an overhead of the decision making based on the determined first frequency periodicity and the determined second frequency periodicity.

To this end, examples of the present disclosure include two alternative processes: (1) one process based on a stochastic subgradient process suitable for a non-smooth and, preferably, convex function, and (2) the other process based on a RL model that operates on a higher level and optimizes (fₗ, fₕ).

In some embodiments, determining (operation 500 in FIG. 5) the first frequency periodicity and determining (operation 502 in FIG. 5) the second frequency periodicity is based on use of a stochastic gradient process.

With reference to such a stochastic subgradient process for the URLLC example discussed herein, a capability is included for estimating/measuring/calculating the overhead O as well as the KPIs of eMBB and URLLC. Additionally, for ease of discussion of this example, a minimal decision-making interval (in other words, a maximum decision frequency) is fixed, which may be a natural assumption for many use cases. For example, for nRet, it may be desirable to make a new decision at the beginning of a coherence interval, and then it may not be desirable (e.g., due to protocol limitations) to change the nRet decision within one coherence interval. Moreover, in this example, a feasible set of decision-making intervals for lower and higher-level decisions are integer multiples of the mentioned interval unit. Thus, in this example, in iteration k of use of the stochastic subgradient process, O^{k} is compared to O^{k-1} (which is the inference overhead obtained by choosing

$${f}_{l}^{k - 1}$$

(i.e., decisions at the last iterations), as well as τ^{k} and A^{k}, the throughput of the eMBB service as well the URLLC availability). Events: E^{k}={O^{k}≤O^{k-1}}∩{τ^{k}≥τₘᵢₙ}∩{A^{k}≥Aₘᵢₙ} are then formed where τₘᵢₙ and Aₘᵢₙ are the minimum acceptable throughout of eMBB and the minimum acceptable availability of the URLLC service. Thus, an event means throughput of eMBB and URLLC services are acceptable while the overhead drops after adopting new frequency decisions. A step size at iteration k is defined by α^{k}, and the following sign function:

$${1}_{X} = \{ \begin{matrix}+ 1 & if X is true \\ - 1 & if X is false\end{matrix}$$

Main iterations are as follows:

$${f}_{l}^{k + 1} = {[ {f}_{l}^{k} - {1}_{{E}^{k}} Δ {f}_{l} {α}^{k} ]}^{†}$$

$$and$$

$${f}_{h}^{k + 1} = {[ {f}_{h}^{k} - {1}_{{E}^{k}} Δ {f}_{h} {α}^{k} ]}^{†}$$

where [x]^{†} is a convex projection of x onto the feasible region, e.g., via the minimum Euclidean distance, and Δfₗ and Δfₕ are the differences between consecutive values of fₗ and fₕ.

In these main iterations, 1_{E}_{^{k}}Δfₗ and 1_{E}_{^{k}}Δfₕ act as subgradients of the gradients of the corresponding objective functions with respect to fₗ and fₕ, respectively. Therefore, this iterative process may be more suitable for invex functions (the scalarized function, i.e., convex combination of O, D and A, should be invex with respect to fₗ and fₕ) in which the iterations mimic stochastic subgradient processes.

In some embodiments, the stochastic gradient process includes a computational model. The computational model chooses a plurality of overhead values for the decision making from a range of overhead values. A respective overhead value corresponds to (i) a value for the first frequency periodicity from a first range of values for the first frequency periodicity and a first KPI for the at least one service, and (ii) a value for the second frequency periodicity from a second range of values for the second frequency periodicity and a second KPI for the at least one service. The computational model further forms a plurality of events. An event includes (i) the respective overhead value is less than or equal to a minimum specified value for the overhead, (ii) the respective first KPI is greater than or equal to a minimum specified value for the first KPI, and (iii) the respective second KPI is greater than or equal to a minimum specified value for the second KPL The computational model further iterates through the plurality of events to identify the first value for the first frequency periodicity and the second value for the second frequency periodicity from the respective range of values for the first frequency periodicity and the second frequency periodicity to determine a result that is a closest value to the minimum specified value for the overhead.

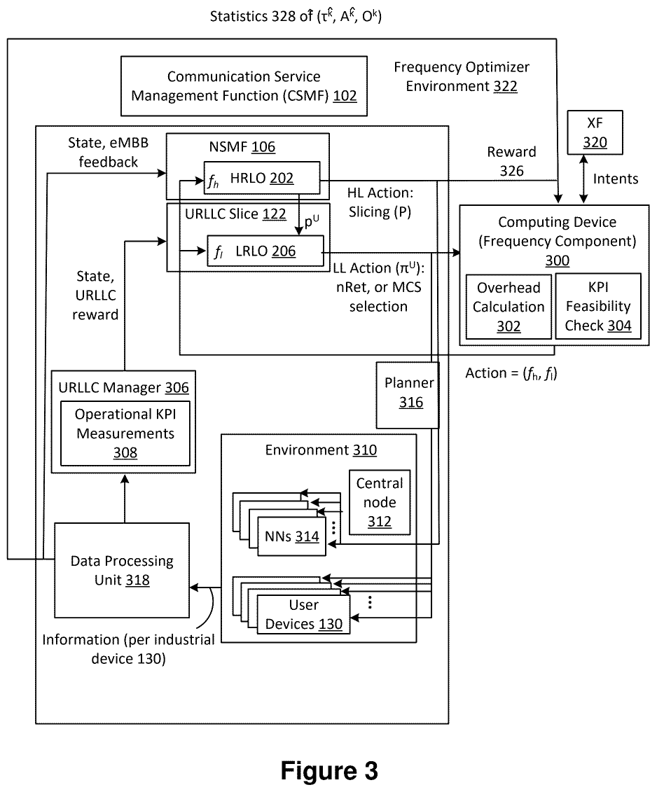

With reference to a RL based process for the URLLC example discussed herein, a RL model is trained. FIG. 3 is a schematic diagram illustrating an overall HRL control architecture that includes a computing device 300 according to some embodiments. The RL model may be, e.g., in computing device 300. As shown in FIG. 3, a frequency optimizer environment 322 includes: CSMF 102; NSMF 106, which includes HRLO 202 control loop; URLLC slice 122, which includes LRLO 206 control loop; URLLC manager 306, which includes operational KPI measurements 308; environment 310, which includes central network node 312, network nodes 314, and user devices 130; planner 316; and data processing unit 318 (e.g., at least one processing circuit). The architecture further includes XF 320 (e.g., an intent management function (IMF); and computing device 300, which also includes an overhead calculation component 302, and a KPI feasibility check component 304.

The trained RL model interacts with an environment 322 and can optimize the decision variables. In this example, the decision variables, or equivalently the actions of the RL model, are fₗ and fₕ, as shown in FIG. 3. In some embodiments, the determining (operation 500 of FIG. 5) the first frequency periodicity and the determining (operation 502 of FIG. 5) the second frequency periodicity is based on use of a RL model of the computing device. Further, in some embodiments, the RL model is trained to optimize the first frequency periodicity and the second frequency periodicity.

Overhead calculation component 302 approximates/calculates overhead O, and KPI feasibility check component 304 calculates a KPI(s) of the services (eMBB and URLLC in this example) and compares them against target KPIs. In some embodiments, the determining (operation 500 in FIG. 5) the first frequency periodicity and the determining (operation 502 in FIG. 5) the second frequency periodicity includes (i) calculating an overhead value for the decision making, (ii) calculating a KPI for the at least one service, and (iii) comparing the calculated KPI against at least one target KPI for the at least one service.

Computing device 300 also can receive a set of intents from XF 320 (e.g., an IMF). Examples of intents can be a feasible region for eMBB throughput, an acceptable region for the URLLC availability, and/or descriptions of overhead O. In some embodiments, the RL model receives as an input a set of intents for the at least one service. The set of intents include the at least one target KPI comprising at least one of a specified range of values for the at least one target KPI, and a specified overhead value or specified range of overhead values.

KPI feasibility check component 304 can be rule-based (e.g., the action (fₗ, fₕ) that pushes URLLC availability below a threshold is not acceptable) or based on an external machine learning (ML) model that is digested as input to KPI feasibility check component 304. In some embodiments, for example, comparing the calculated KPI against the at least one target KPI for the at least one service is performed by using at least one of a rule-based comparison and an external ML model.

Planner 316 receives the actions and inputs them to the central network node 312, network nodes 314, and user devices 130 in environment 310, which execute the actions. Information per user device 130 is input to data processing unit 318; and data processing unit 316 outputs (i) a state per user device 130 to URLLC manager 306 and NSMF 106, and (ii) statistics 328 (discussed further herein) to computing device 300.

Depending on the intents, a reward 326 can be a function of O, A, and τ. In some embodiments, for example, the RL model receives a reward including .a function of (i) a first parameter characterizing an overhead of the decision making, (ii) the first frequency periodicity and the second frequency periodicity, and (iii) a second parameter characterizing at least one KPI for the at least one service.

In iteration k, in the above example, the state of the RL model is statistics 328 of the parameters characterizing the URLLC availability (e.g., packet error ratio, buffer status, signal to interference noise ratio (SINR), delay, path gain, link outage duration for all URLLC devices), denoted by Â^{k}; the parameters characterizing the throughput of eMBB (e.g., SINR and buffer status) denoted by \hat{τ}^{k}; as well as statistics of the parameters characterizing the overhead, denoted by Ô^{k}. Examples of these parameters can be the number of signals, or the energy/delay/etc. associated with them, to run HRL.

Obtaining KPIs for one set of (fₗ, fₕ) may be time-consuming, and the process of optimizing (fₗ, fₕ) may entail some explorations. This exploration may lead to poor KPIs, which may not be acceptable for URLLC or eMBB services, for example. In some embodiments, the RL model is trained in at least one of an offline mode and an online mode.

In some embodiments, at least one service includes an URLLC service that co-exists with an eMBB service. In such embodiments, the first decision variable for the operation of the URLLC service includes at least one of a bandwidth and a power to control slicing, and the second decision variable for the operation of the URLLC service includes at least one of a MCS to control packet transmission reliability and a number of retransmissions to control packet transmission reliability.

An example implementation of an RL model in the context of an example for URLLC and eMBB services includes using off-policy RL algorithms (e.g., soft actor-critic, deep Q-networks). Hence, such off-policy RL algorithms may be capable of both off-policy (either in offline or online mode) and on-policy training. In the off-policy offline setting, there is no interaction with the environment, and a dataset is collected using an unknown behavior policy. In the off-policy online setting, when interactions with the environment are permitted, new experienced transitions are added to the buffer, and several transitions from the buffer (which may include replays) are used to update the new policy. In the on-policy online setting, the formulation changes from episodic to infinite horizon RL. Additionally, the RL algorithm may access only the latest transition (e.g., there is no buffer), and consequently, the actions may be sampled and executed via the most recent estimate of policy (i.e., the behavior policy and target policy are identical in this case). This characteristic may be significant when dealing with URLLC services in which there may be no tolerance for losing a strict requirement of a URLLC service. Leveraging this capability, a ML model can be trained (e.g., a neural network), using (i) an already existing dataset in offline mode, (ii) a virtual network (e.g., realistic simulations or digital twin) in off-policy mode, while the episodes can run in parallel to speed up the learning procedure, and (iii) the operational network (e.g., in safe exploration mode in which the industrial devices are not executing their critical functions) to tune the parameters of the ML model.

In some examples, operations discussed herein can be applied to control loops that run on various networking layers. Some examples include applicability of operations discussed herein for use cases that are focused on the first three layers of a RAN air interface (e.g., Layer 1 (L1), Layer 2 (L2), and Layer 3 (L3)) Other use cases include, without limitation, radio resource allocation, modulation and coding scheme selection, and scheduling of network slice partitions.

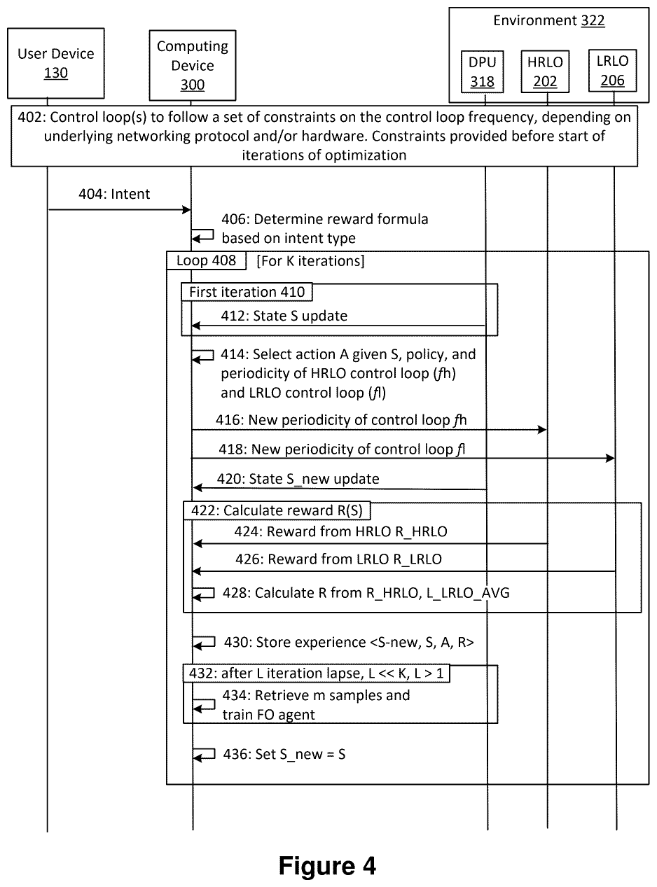

FIG. 4 is a sequence diagram for the example shown in FIG. 3 according to some embodiments. Block 402 identifies context for the sequence diagram, namely: A control loop(s) is to follow a set of constraints on the control loop(s) frequency, depending on an underlying networking protocol and/or hardware. The constraints are provided before the start of iterations of the optimization. In operation 404, a user device 130 in environment 310, signals an intent to computing device 300. As previously discussed, the intent can be a feasible region for eMBB throughput, an acceptable region for the URLLC availability, and/or descriptions of overhead O. Computing device 300, in operation 406, determines a reward formula based on the intent type. As previously discussed, the reward formula can be a function of O, A, and T. Loop 408 includes k iterations and includes: operation 412 of first iteration 410; operations 414-420; calculating a reward 422 in operations 424-428; operation 430; operation 434 for the lapse 432; and operation 436.

In first iteration 410, data processing unit 318 of environment 322 signals a state S update to computing device 300. In operation 414, computing device 300 selects an action A given S, policy, and a periodicity fₕ of HRLO 202 control loop and a periodicity fₗ of LRLO 206 control loop. Computing device 300, in operations 416 and 418, respectively, signals the selected periodicity fₕ to HRLO 202 control loop and the selected periodicity fₗ to LRLO 206 control loop. In operation 420, data processing unit 318 signals anew state (S-new) update to computing device 300.

A reward 422 for the new state (S-new) is calculated in operations 424-428. In operation 424, HRLO 202 control loop signals a reward (R_HRLO) to computing device 300; and in operation 426, LRLO 206 control loop signals a reward (R_LRLO) to computing device 300. Computing device 300, in operation 428, calculates 422 the reward R 326 from an average of R_HRLO and R_LRLO.

In operation 430, computing device 300 stores the experience <S-new, S, A, R>.

After an L iteration lapse 432, L<<k, L>1, in operation 434, computing device 300 retrieves m samples and trains the RL model.

In operation 436, computing device 300 sets the new state S-new as the state S.

As previously indicated, certain embodiments may provide one or more of the following technical advantages. Based on determining frequency of decision makings at different levels, the method and operations may provide improved performance of hierarchical decision making tools (e.g., a computational model or HRL) in edge computing for cellular networks, for example. The method and operations may further provide compatibility with fast decision making cycles, for example, related to O-RAN standardization on an A1 interface between non and near RT RICs, as shown in the Example in FIG. 2.

Further network slices' bandwidth may be changed by NSMF, or NSSMF, because the bandwidth is a quality of service (QoS) attribute that describes static parameters and a functional component of a network slice subnet. Thus, a horizontal approach may train all decision variables using a long time scale, which may result in a long training time, and consequently lead to much higher energy consumption and network overhead due to excessive processing and communication. In contrast, a further technical advantage of determining frequency of decision makings at different levels may resolve these challenges, as discussed herein regarding the URLLC example.

Further, with reference to the URLLC examples discussed herein, a further technical advantage of determining frequency of decision makings at different levels may be improved decision cycles for nRet and MCS selection (and other potential decision variables) for a URLLC service as well as slicing for various services, which may ensure efficient closed-loop collaborations between high-level decisions and low-level decisions. In this example, the slicing module (HRLO) may better cooperate with LRLO to reach target performance of the eMBB and URLLC services with minimum resources while tracking dynamics of the environment. This may result in (i) more available resource for other parallel services (e.g., mMTC); (ii) cheaper operating expenditure (OpEx) for a business since similar performance may be achieved with much less resources (e.g., if no other service is intended in the network); and/or (iii) lower energy consumption as various entities may send less control signals due to the optimized/improved decision frequency. For example, by deciding on the nRet value in every other slot, instead of every slot, there may be a 50% savings of the transmitted control signals needed to make a new decision by the RL model.

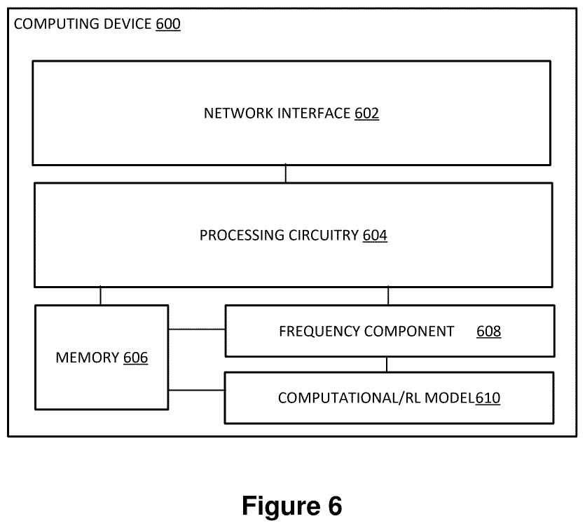

Operations of a computing device can be performed by the computing device 600 of FIG. 6. Operations of the computing device (implemented using the structure of FIG. 6) have been discussed with reference to the flow chart of FIG. 5 according to some embodiments of the present disclosure. For example, modules may be stored in memory 606, frequency component 608, and/or the computational/RL model 610 of FIG. 6, and these modules may provide instructions so that when the instructions of a module are executed by respective computing device processing circuitry 604, computing device 600 performs respective operations of the flow chart of FIG. 5.

As shown in FIG. 6, the computing device 600 includes processing circuitry 604 that is operatively coupled to memory 606, network interface 602, frequency component 608, and computational/RL model 610, and/or any other component, or any combination thereof. Certain computing devices may utilize all or a subset of the components shown in FIG. 6. The level of integration between the components may vary from one computing device to another computing device. Further, certain computer devices may contain multiple instances of a component, such as multiple processors, memories, computational models, RL models, etc.

The processing circuitry 604 is configured to process instructions and data and may be configured to implement any sequential state machine operative to execute instructions stored as machine-readable computer programs in the memory 606, frequency component 608, and/or computational/RL model 610. The processing circuitry 604 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 604 may include multiple central processing units (CPUs).

In the example, the network interface 602 may be configured to provide an interface or interfaces to an input device, output device, or one or more input and/or output devices. Examples of an output device include a display, a monitor, a printer, another output device, or any combination thereof. An input device may allow a user to capture information into the computing device 600. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, a force sensor, an optical sensor, a proximity sensor, a biometric sensor, etc., or any combination thereof. An output device may use the same type of interface port as an input device. For example, a Universal Serial Bus (USB) port may be used to provide an input device and an output device.

The memory 606, frequency component 608, and/or computational/RL model 610 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 606, frequency component 608, and/or computational/RL model 610 includes one or more application programs, such as an operating system, web browser application, a widget, gadget engine, or other application, and corresponding data. The memory 606, frequency component 608, and/or computational/RL model 610 may store, for use by the computing device 600, any of a variety of various operating systems or combinations of operating systems.

The memory 606, frequency component 608, and/or computational/RL model 610 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 606, frequency component 608, and/or computational/RL model 610 may allow the computing device 600 to access instructions, application programs and the like, stored on transitory or non-transitory memory media, to off-load data, or to upload data. An article of manufacture, such as one utilizing a communication system may be tangibly embodied as or in the memory 606, frequency component 608, and/or computational/RL model 610 which may be or comprise a device-readable storage medium.

The processing circuitry 604 may be configured to communicate with a network using the network interface 602. The network interface 602 may comprise one or more communication subsystems. The network interface 602 may include one or more transceivers used to communicate, such as by communicating with one or more remote transceivers of another device capable of wireless communication (e.g., another computing device, edge node, cloud node, etc.). Each transceiver may include a transmitter and/or a receiver appropriate to provide network communications (e.g., optical, electrical, and so forth).

In the illustrated embodiment, communication functions of the network interface 602 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Functions implemented by some embodiments may be virtualized. In the present context, virtualizing means creating virtual versions of apparatuses or computing devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more VMs implemented in one or more virtual environments hosted by one or more of hardware nodes, such as a hardware computing device that operates as an edge node or cloud node. Further, in embodiments the virtual node may be entirely virtualized.

Applications (which may alternatively be called software instances, virtual appliances, network functions, virtual nodes, virtual network functions, etc.) can be run in the virtualization environment to implement some of the features, functions, and/or benefits of some of the embodiments disclosed herein.

Although the computing devices described herein may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In certain embodiments, a computing device (300, 600) configured to determine a plurality of frequency periodicities for decision making for an operation of at least one service in a communication network is provided, where the computing device is adapted to perform some or all of the functionality described herein.

In certain embodiments, a computer program product including a non-transitory storage medium (606, 608, 610) including program code to be executed by processing circuitry (604) of a computing device (300, 600) configured to determine a plurality of frequency periodicities for decision making for an operation of at least one service in a communication network is provided, whereby execution of the program code causes the computing device to perform some or all of the functionality described herein

In certain embodiments, a computer program including program code to be executed by processing circuitry (604) of a computing device (300, 600) configured to determine a plurality of frequency periodicities for decision making for an operation of at least one service in a communication network is provided, whereby execution of the program code causes the computing device to perform operations including to perform some or all of the functionality described herein.

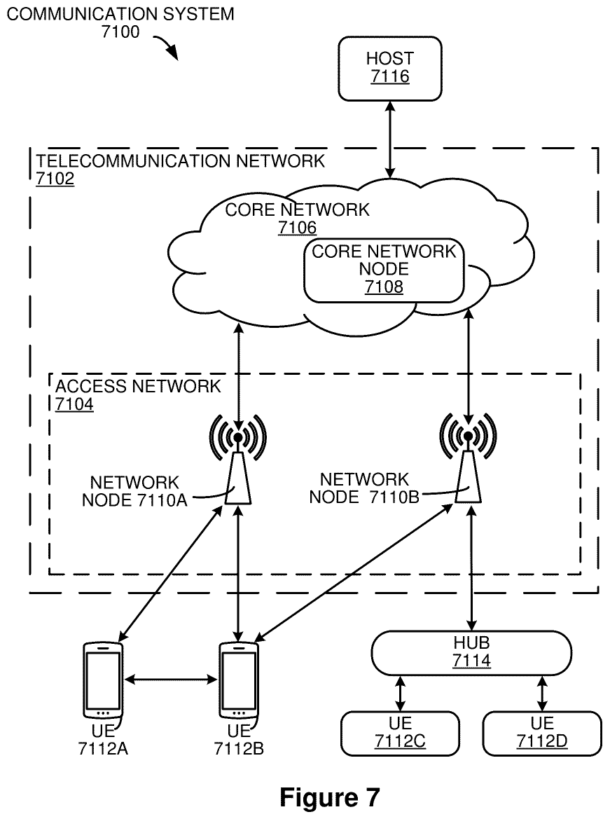

FIG. 7 shows an example of a communication system (also referred to herein as a “communication network”) 7100 in accordance with some embodiments.

In the example, the communication system 7100 includes a telecommunication network 7102 that includes an access network 7104, such as a RAN, and a core network 7106, which includes one or more core network nodes 7108. The access network 7104 includes one or more access network nodes, such as network nodes 7110a and 7110b (one or more of which may be generally referred to as network nodes 7110), or any other similar 3^{rd} Generation Partnership Project (3GPP) access node or non-3GPP access point. The network nodes 7110 facilitate direct or indirect connection of user equipment (UE) (also referred to herein as “user device”), such as by connecting UEs 7112a, 7112b, 7112c, and 7112d (one or more of which may be generally referred to as UEs 7112) to the core network 7106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 7100 may include any number of wired or wireless networks, network nodes, UEs, and/or any other components or systems that may facilitate or participate in the communication of data and/or signals whether via wired or wireless connections. The communication system 7100 may include and/or interface with any type of communication, telecommunication, data, cellular, radio network, and/or other similar type of system.

The UEs 7112 may be any of a wide variety of communication devices, including wireless devices arranged, configured, and/or operable to communicate wirelessly with the network nodes 7110 and other communication devices. Similarly, the network nodes 7110 are arranged, capable, configured, and/or operable to communicate directly or indirectly with the UEs 7112 and/or with other network nodes or equipment in the telecommunication network 7102 to enable and/or provide network access, such as wireless network access, and/or to perform other functions, such as administration in the telecommunication network 7102.

In the depicted example, the core network 7106 connects the network nodes 7110 to one or more hosts, such as host 7116. These connections may be direct or indirect via one or more intermediary networks or devices. In other examples, network nodes may be directly coupled to hosts. The core network 7106 includes one more core network nodes (e.g., core network node 7108) that are structured with hardware and software components. Features of these components may be substantially similar to those described with respect to the UEs, network nodes, and/or hosts, such that the descriptions thereof are generally applicable to the corresponding components of the core network node 7108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 7116 may be under the ownership or control of a service provider other than an operator or provider of the access network 7104 and/or the telecommunication network 7102, and may be operated by the service provider or on behalf of the service provider. The host 7116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 7100 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 7102 is a cellular network that implements 3GPP standardized features. Accordingly, the telecommunications network 7102 may support network slicing to provide different logical networks to different devices that are connected to the telecommunication network 7102. For example, the telecommunications network 7102 may provide URLLC services to some UEs, while providing eMBB services to other UEs, and/or mMTC/Massive IoT services to yet further UEs.

In some examples, the UEs 7112 are configured to transmit and/or receive information without direct human interaction. For instance, a UE may be designed to transmit information to the access network 7104 on a predetermined schedule, when triggered by an internal or external event, or in response to requests from the access network 7104. Additionally, a UE may be configured for operating in single- or multi-RAT or multi-standard mode. For example, a UE may operate with any one or combination of Wi-Fi, NR and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 7114 communicates with the access network 7104 to facilitate indirect communication between one or more UEs (e.g., UE 7112c and/or 7112d) and network nodes (e.g., network node 7110b). In some examples, the hub 7114 may be a controller, router, content source and analytics, or any of the other communication devices described herein regarding UEs. For example, the hub 7114 may be a broadband router enabling access to the core network 7106 for the UEs. As another example, the hub 7114 may be a controller that sends commands or instructions to one or more actuators in the UEs. Commands or instructions may be received from the UEs, network nodes 7110, or by executable code, script, process, or other instructions in the hub 7114. As another example, the hub 7114 may be a data collector that acts as temporary storage for UE data and, in some embodiments, may perform analysis or other processing of the data. As another example, the hub 7114 may be a content source. For example, for a UE that is a VR headset, display, loudspeaker or other media delivery device, the hub 7114 may retrieve VR assets, video, audio, or other media or data related to sensory information via a network node, which the hub 7114 then provides to the UE either directly, after performing local processing, and/or after adding additional local content. In still another example, the hub 7114 acts as a proxy server or orchestrator for the UEs, in particular if one or more of the UEs are low energy IoT devices.

The hub 7114 may have a constant/persistent or intermittent connection to the network node 7110b. The hub 7114 may also allow for a different communication scheme and/or schedule between the hub 7114 and UEs (e.g., UE 7112c and/or 7112d), and between the hub 7114 and the core network 7106. In other examples, the hub 7114 is connected to the core network 7106 and/or one or more UEs via a wired connection. Moreover, the hub 7114 may be configured to connect to an M2M service provider over the access network 7104 and/or to another UE over a direct connection. In some scenarios, UEs may establish a wireless connection with the network nodes 7110 while still connected via the hub 7114 via a wired or wireless connection. In some embodiments, the hub 7114 may be a dedicated hub—that is, a hub whose primary function is to route communications to/from the UEs from/to the network node 7110b. In other embodiments, the hub 7114 may be a non-dedicated hub—that is, a device which is capable of operating to route communications between the UEs and network node 7110b, but which is additionally capable of operating as a communication start and/or end point for certain data channels.

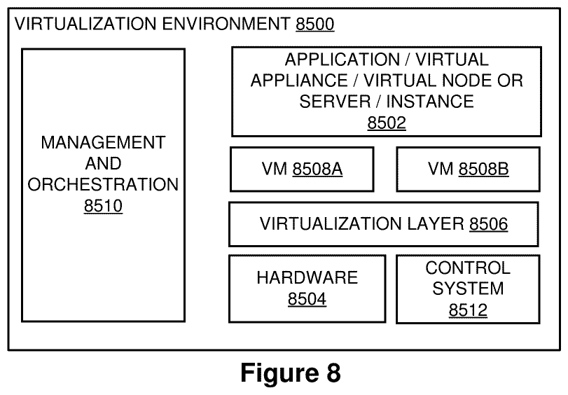

FIG. 8 is a block diagram illustrating a virtualization environment 8500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more VMs implemented in one or more virtual environments 8500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 8502 (which may alternatively be called software instances, virtual appliances, network functions, virtual nodes, virtual network functions, etc.) are run in the virtualization environment 8500 to implement some of the features, functions, and/or benefits of some of the embodiments disclosed herein.

Hardware 8504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 8506 (also referred to as hypervisors or virtual machine monitors (VMMs)), provide VMs 8508a and 8508b (one or more of which may be generally referred to as VMs 8508), and/or perform any of the functions, features and/or benefits described in relation with some embodiments described herein. The virtualization layer 8506 may present a virtual operating platform that appears like networking hardware to the VMs 8508.

The VMs 8508 comprise virtual processing, virtual memory, virtual networking or interface and virtual storage, and may be run by a corresponding virtualization layer 8506. Different embodiments of the instance of a virtual appliance 8502 may be implemented on one or more of VMs 8508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 8508 may be a software implementation of a physical machine that runs programs as if they were executing on a physical, non-virtualized machine. Each of the VMs 8508, and that part of hardware 8504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 8508 on top of the hardware 8504 and corresponds to the application 8502.

Hardware 8504 may be implemented in a standalone network node with generic or specific components. Hardware 8504 may implement some functions via virtualization. Alternatively, hardware 8504 may be part of a larger cluster of hardware (e.g. such as in a data center or CPE) where many hardware nodes work together and are managed via management and orchestration 8510, which, among others, oversees lifecycle management of applications 8502. In some embodiments, hardware 8504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 8512 which may alternatively be used for communication between hardware nodes and radio units.

Further definitions and embodiments are discussed below.

In the above-description of certain embodiments of the present disclosure, it is to be understood that the terminology used herein is for the purpose of describing particular embodiments only and is not intended to be limiting of the present disclosure. Unless otherwise defined, all terms (including technical and scientific terms) used herein have the same meaning as commonly understood by one of ordinary skill in the art to which concepts of the present disclosure belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of concepts of the present disclosure. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components, or functions but does not preclude the presence or addition of one or more other features, integers, elements, steps, components, functions, or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of the present disclosure. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present disclosure. All such variations and modifications are intended to be included herein within the scope of present disclosure. Accordingly, the above disclosed subject matter is to be considered illustrative, and not restrictive, and the examples of embodiments are intended to cover all such modifications, enhancements, and other embodiments, which fall within the spirit and scope of the present disclosure. Thus, to the maximum extent allowed by law, the scope of the present disclosure is to be determined by the broadest permissible interpretation of the present disclosure including the examples of embodiments and their equivalents, and shall not be restricted or limited by the foregoing detailed description.

1. A computer-implemented method performed by a computing device to determine a plurality of frequency periodicities for decision making for an operation of at least one service in a communication network, the method comprising:
determining a first frequency periodicity for a first decision variable for the operation of the at least one service;
determining a second frequency periodicity for a second decision variable for the operation of the at least one service, wherein the first frequency periodicity is different than the second frequency periodicity; and
outputting the first frequency periodicity for the first decision variable and the second frequency periodicity for the second decision variable.

2. The method of claim 1, wherein the outputting is to at least one controller and at least one control loop for the decision making on the first and second decision variables for operation of the at least one service.

3. The method of claim 2, wherein the outputting is to a plurality of controllers for a plurality of control loops for the decision making on the first and second decision variables for operation of the at least one service, and wherein the plurality of control loops comprise a first control loop for the decision making on the first decision variable at the first frequency periodicity and a second control loop is for the decision making on the second decision variable at the second frequency periodicity.

4. The method of claim 1, wherein the first frequency periodicity is for a first decision on the first decision variable at a first level of a hierarchical reinforcement learning, HRL, model for the operation of the least one service, and the second frequency periodicity is for a decision on the second decision variable at a second level of the HRL model for the operation of the least one service.

5. The method of claim 1, wherein
one of the first frequency periodicity and the second frequency periodicity has a higher periodicity than a periodicity of the other of the first frequency periodicity and the second frequency periodicity,
the one of the first frequency periodicity and the second frequency periodicity that has the higher periodicity is output to a first orchestrator for the at least one service that interacts with the communication network and orchestrates a control of the plurality of frequency periodicities for the decision making, and
the other of the first frequency periodicity and the second frequency periodicity is output to a second orchestrator for the at least one service.

6. The method of claim 2, wherein the at least one control loop is subject to at least one constraint on at least one of the first frequency periodicity and the second frequency periodicity based on a network protocol and/or hardware related to the operation of at least one service.

7. The method of claim 1, wherein a first decision is made for the first decision variable at the first frequency periodicity and a second decision is made for the second decision variable at the second frequency periodicity.

8. The method of claim 7, wherein the first decision and the second decision result in a reduction or a minimization of an overhead of the decision making based on the determined first frequency periodicity and the determined second frequency periodicity.

9. The method of claim 1, wherein the determining the first frequency periodicity and the determining the second frequency periodicity is based on use of a stochastic gradient process.

10. The method of claim 9, wherein the stochastic gradient process comprises a computational model, wherein the computational model
chooses a plurality of overhead values for the decision making from a range of overhead values, wherein a respective overhead value corresponds to (i) a value for the first frequency periodicity from a first range of values for the first frequency periodicity and a first key performance indicator, KPI, for the at least one service, and (ii) a value for the second frequency periodicity from a second range of values for the second frequency periodicity and a second KPI for the at least one service;
forms a plurality of events, wherein an event comprises (i) the respective overhead value is less than or equal to a minimum specified value for the overhead, (ii) the respective first KPI is greater than or equal to a minimum specified value for the first KPI, and (iii) the respective second KPI is greater than or equal to a minimum specified value for the second KPI; and
iterates through the plurality of events to identify the first value for the first frequency periodicity and the second value for the second frequency periodicity from the respective range of values for the first frequency periodicity and the second frequency periodicity to determine a result that is a closest value to the minimum specified value for the overhead.

11. The method of claim 1, wherein the determining the first frequency periodicity and the determining the second frequency periodicity is based on use of a reinforcement learning, RL, model of the computing device.

12. The method of claim 11, wherein the RL model is trained to optimize the first frequency periodicity and the second frequency periodicity.

13. The method of claim 11, wherein the determining the first frequency periodicity and the determining the second frequency periodicity comprises (i) calculating an overhead value for the decision making, (ii) calculating a key performance indicator, KPI, for the at least one service, and (iii) comparing the calculated KPI against at least one target KPI for the at least one service.

14. The method of claim 13, wherein the RL model receives as an input a set of intents for the at least one service, wherein the set of intents comprise the at least one target KPI comprising at least one of a specified range of values for the at least one target KPI, and a specified overhead value or specified range of overhead values.

15. The method of claim 13, wherein the comparing the calculated KPI against the at least one target KPI for the at least one service is performed by using at least one of a rule-based comparison and an external machine learning, ML, model.

16. The method of claim 11, wherein the RL model receives a reward comprising a function of (i) a first parameter characterizing an overhead of the decision making, (ii) the first frequency periodicity and the second frequency periodicity, and (iii) a second parameter characterizing at least one key performance indicator, KPI, for the at least one service.

17. The method of claim 11, wherein the RL model is trained in at least one of an offline mode and an online mode.

18. The method of claim 1, wherein the at least one service comprises an ultra-reliable low latency communication, URLLC, service that co-exists with an enhanced mobile broadband, eMBB, service.

19. The method of claim 18, wherein the first decision variable for the operation of the URLLC service comprises at least one of a bandwidth and a power to control slicing, and the second decision variable for the operation of the URLLC service comprises at least one of a modulation and coding scheme, MCS, to control packet transmission reliability and a number of retransmissions to control packet transmission reliability.

20. A computing device configured to determine a plurality of frequency periodicities for decision making for an operation of at least one service in a communication network, the computing device comprising:
processing circuitry;
memory coupled with the processing circuitry, wherein the memory includes instructions that when executed by the processing circuitry causes the computing device to perform operations comprising:
determine a first frequency periodicity for a first decision variable for the operation of the at least one service;
determine a second frequency periodicity for a second decision variable for the operation of the at least one service, wherein the first frequency periodicity is different than the second frequency periodicity; and
output the first frequency periodicity for the first decision variable and the second frequency periodicity for the second decision variable.

21.-23. (canceled)
